(19) United States
(12) Patent Application Publication
(10) Pub. No.: US 2015/0048127 A1
(43) Pub. Date: Feb. 19, 2015

(54) Ergonomic Ladder Rack

(71) Applicant: ABLE, INC., Yukon, OK (US)

(72) Inventors: Jeffery Wayne Sutton, Oklahoma City, OK (US); Roman Shawn Meeks, Edmond, OK (US); Mark Edward Sharp, Oklahoma City, OK (US)

(73) Assignee: ABLE, INC., Yukon, OK (US)

(21) Appl. No.: 14/461,806

(22) Filed: Aug. 18, 2014

Related U.S. Application Data
(60) Provisional application No. 61/867,118, filed on Aug. 18, 2013.

(51) Int. Cl. B60R 9/04

(52) U.S. Cl. CPC B60R 9/04
USPC 224/324

(57) ABSTRACT

Embodiments of the Ergonomic Ladder Rack are comprised of two or more fixed cross-members, one or more inner axis rods, one or more stops, two or more ladder support arms, one or more fluid or gas filled dampers, two or more ladder hooks, two or more ladder stop/securing arms, one or more connecting tubes, and a handle assembly. The cross-members are spaced on the vehicle in such a way as to traverse much of the length of the vehicle. The inner axis rod is placed perpendicular through apertures formed by the fixed cross-members. The connecting tubes extend between each fixed cross-member allow each ladder support arms to rotate in combination with the others. The handle assembly is comprised of a handle, a pair of support braces, a handle axis tube, a bat wing bracket, a rear bushing, a front bushing, and a securing bolt.

### CROSS-REFERENCE TO RELATED APPLICATIONS

This application is a non-provisional patent application of pending U.S. provisional patent application with Ser. No. 61/867,118 titled “Ergonomic Ladder Rack” filed on Aug. 18, 2013. This application claims priority of U.S. provisional patent application with Ser. No. 61/867,118, and the entire contents of U.S. provisional patent application with Ser. No. 61/867,118 is herein incorporated by reference.

### STATEMENT REGARDING FEDERALLY SPONSORED RESEARCH OR DEVELOPMENT

Not applicable

### BACKGROUND OF THE EMBODIMENTS

1. Field of the Embodiments

The field of the embodiments of the Ergonomic Ladder Rack is generally ladder support devices. More specifically, the field of the embodiments is ladder support devices mounted to vehicles for transport of ladders.

2. Description of Prior Art

The prior art involves the support means mounted to the bed, top or sides of vans, pickup or utility trucks for ladders. The support means can be as rudimentary as a bracket mounted to the truck in which the ladder rests on the truck. The support means can also comprise a metal frame installed onto the truck bed or top of a van.

There are many drawbacks to the current state of the art in ladder support devices. Most significantly, current inventions require significant repetitive exertion by the user of the ladder support devices. This repetitive exertion can cause injury to the user. Further, the user of many current inventions requires the user to climb a ladder or the bumper of the vehicle to reach the ladder. This also poses the possibility of injury. The embodiments of the Ergonomic Ladder Rack addresses these concerns.

### SUMMARY OF THE EMBODIMENTS

Embodiments of the Ergonomic Ladder Rack are comprised of two or more fixed cross-members, one or more inner axis rods, one or more stops, two or more ladder support arms, one or more fluid or gas filled dampers, two or more ladder hooks, two or more ladder stop/securing arms, one or more connecting tubes, and a handle assembly.

There has thus been outlined, rather broadly, the more important features of the embodiments of the Vehicle Ladder Mounting System for Custom Installations in order that the detailed description thereof that follows may be better understood, and in order that the present contribution to the art may be better appreciated. There are, of course, additional features of the embodiments that will be described hereinafter and which will form the subject matter of the claims appended hereto.

In this respect, before explaining at least one embodiment of the embodiments in detail, it is to be understood that the embodiment is not limited in this application to the details of construction and to the arrangements of the components set forth in the following description or illustrated in the drawings. The embodiment or embodiments are capable of other embodiments and of being practiced and carried out in various ways. Also, it is to be understood that the phraseology and terminology employed herein are for the purpose of description and should not be regarded as limiting. As such, those skilled in the art will appreciate that the conception, upon which this disclosure is based, may readily be used as a basis for the designing of other structures, methods and systems for carrying out the several purposes of the embodiments. Additional benefits and advantages of the embodiments will become apparent in those skilled in the art to which the present embodiments relates from the subsequent description of the preferred embodiment and the appended claims, taken in conjunction with the accompanying drawings. It is important, therefore, that the claims be regarded as including such equivalent constructions insofar as they do not depart from the spirit and scope of the embodiments.

Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application. The abstract is neither intended to define the embodiments of the application which is measured by the claims, nor is it intended to be limiting as to the scope of the embodiments in any way.

### BRIEF DESCRIPTION OF THE DRAWINGS

FIG. 1A is a perspective view of the ergonomic ladder rack shown in the closed position; FIG. 1B is a perspective view of an embodiment of the ergonomic ladder rack shown in the open or extended position.

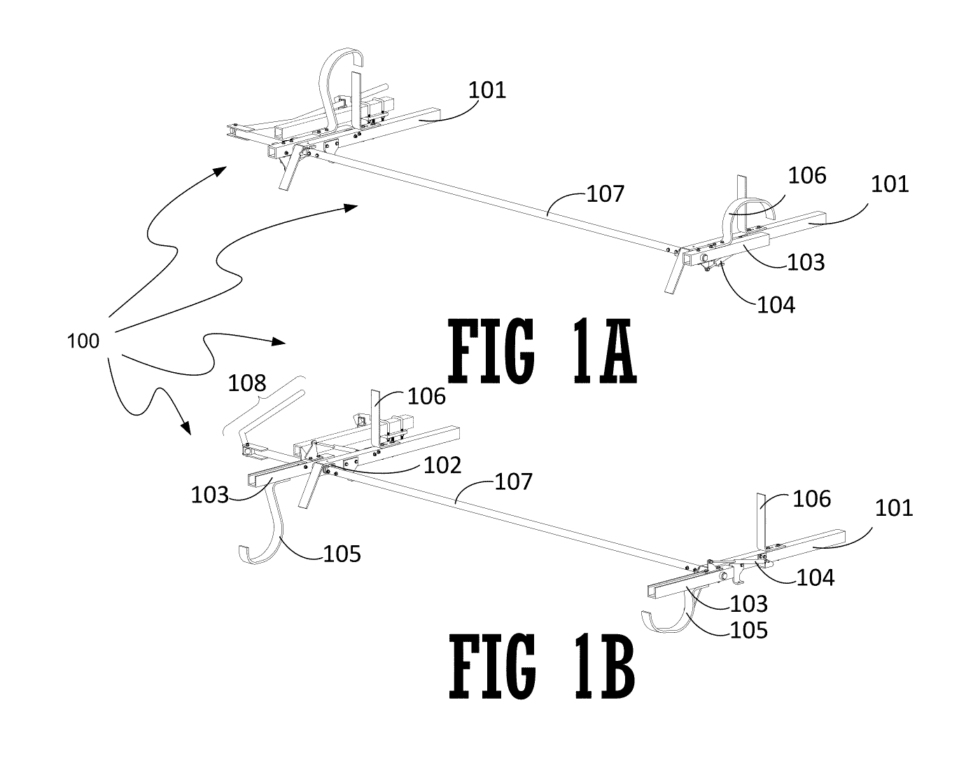

FIG. 2A is a top view of an embodiment of the ergonomic ladder rack showing the ladder rack in the closed position; FIG. 2B is a side view of an embodiment of the ergonomic ladder rack in the closed position.

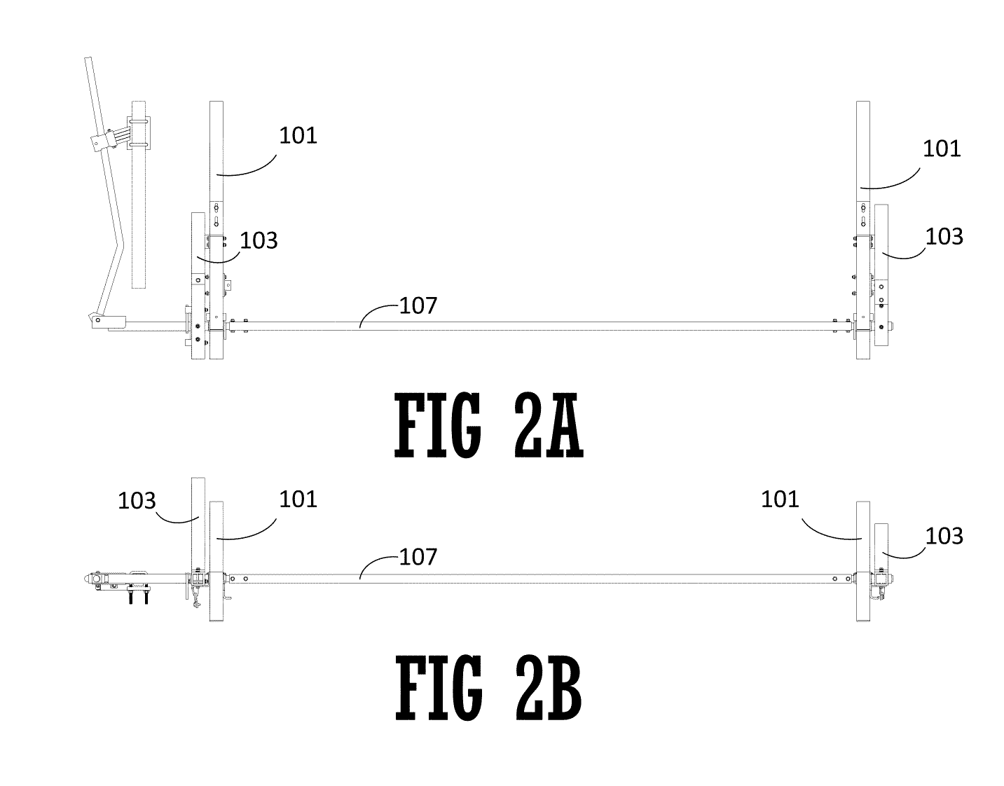

FIG. 3A is a side view of an embodiment of the ergonomic ladder rack showing the ladder rack in the closed position; FIG. 3B is a side view of an embodiment of the ergonomic ladder rack in the open position.

FIG. 4 is a perspective view of an embodiment of the damping assembly of an embodiment of the ergonomic ladder rack shown in the partially open position.

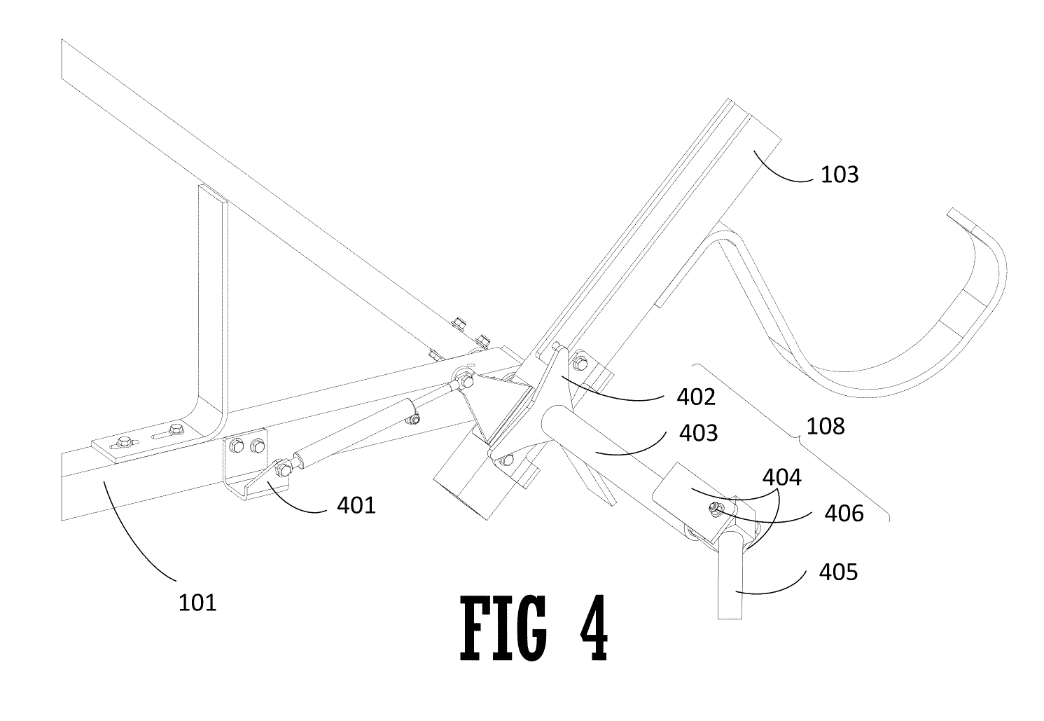

FIG. 5A is a side view of an embodiment of the ergonomic ladder rack showing the ladder rack in the fully closed position; FIG. 5B is a side view of an embodiment of the ergonomic ladder rack shown in the partially open position; FIG. 5C is a side view of an embodiment of the ergonomic ladder rack in the half open position.

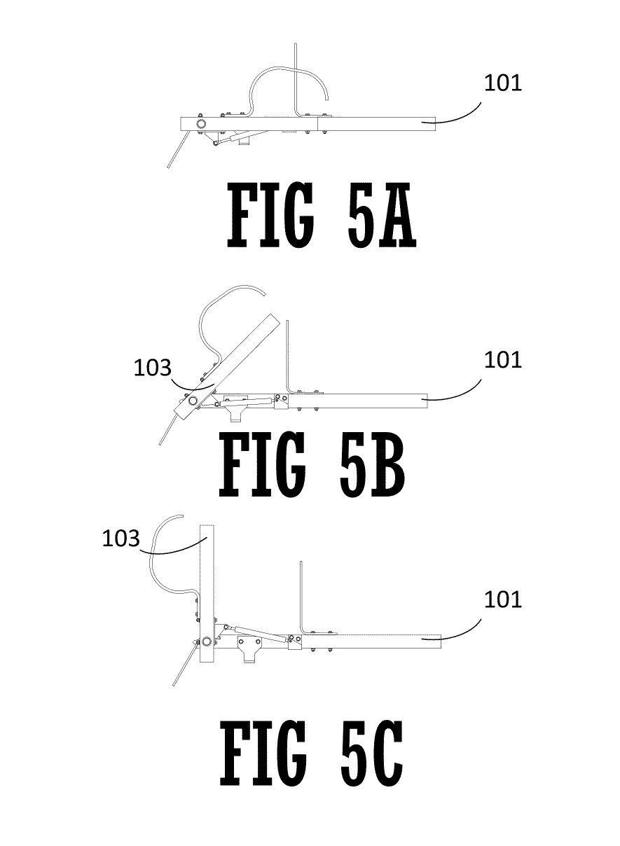

FIG. 6A is a side view of an embodiment of the ergonomic ladder rack showing the ladder rack in the nearly opened position; FIG. 6B is a side view of a embodiment of the ergonomic ladder rack with the ladder rack in the fully open position.

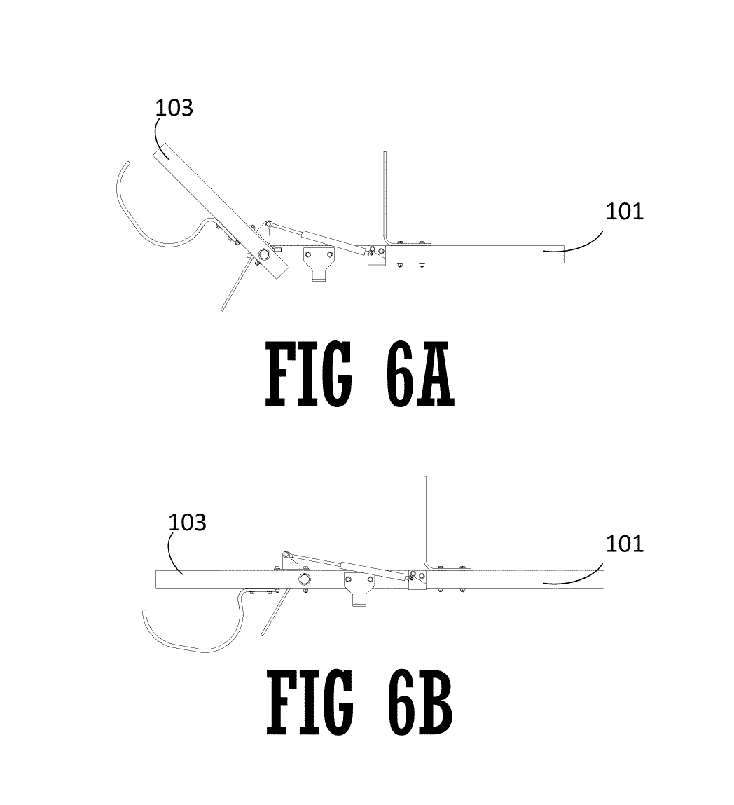

FIG. 7A is a side view of an embodiment of the ergonomic ladder rack showing the positioning of the gas cylinder in the fully closed position; FIG. 7B is a side view of an embodiment of the ergonomic ladder rack showing the gas cylinders in the partially open position; FIG. 7C is a side view of the ergonomic ladder rack showing the positioning of the gas cylinders in a half open position; FIG. 7D is a side view of an embodiment of the ergonomic ladder rack showing the positioning of the gas cylinder in nearly open position; FIG. 7E is a side view of an embodiment of the ergonomic ladder rack showing the positioning of the gas cylinder in the fully open position.

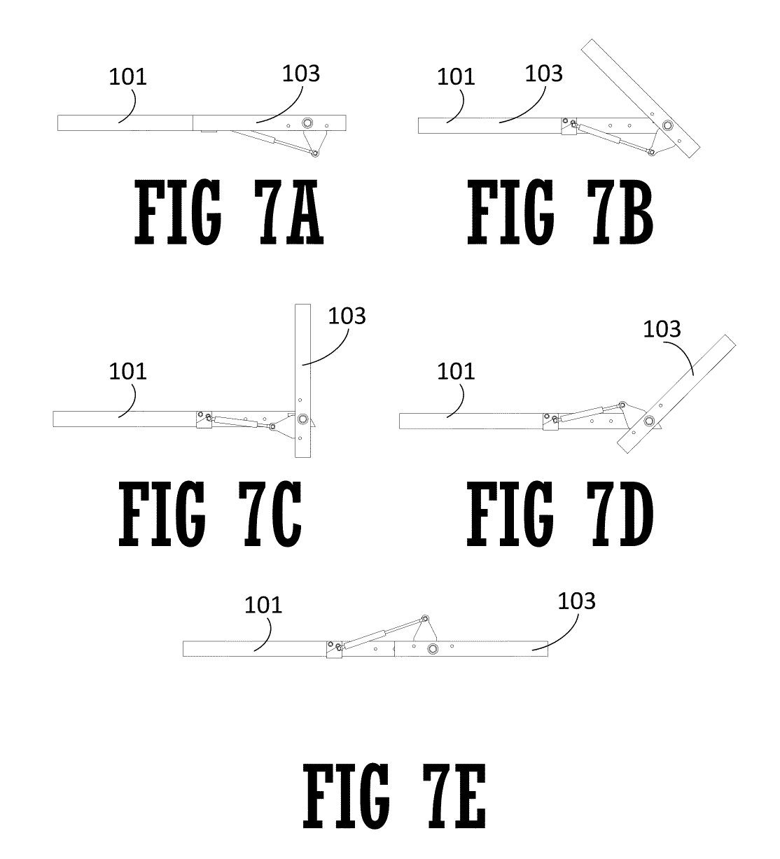

FIG. 8A is a perspective view of an embodiment of the ergonomic ladder rack in the fully open position; FIG. 8B is a perspective view of an embodiment of the ergonomic ladder rack in the fully closed position. FIG. 8C is a side view of the stop in a nearly open position. FIG. 8D is a side view of the stop in the fully open position. FIGS. 8A and 8B should be viewed in conjunction with FIGS. 9A, 9B, 9C and 9D.

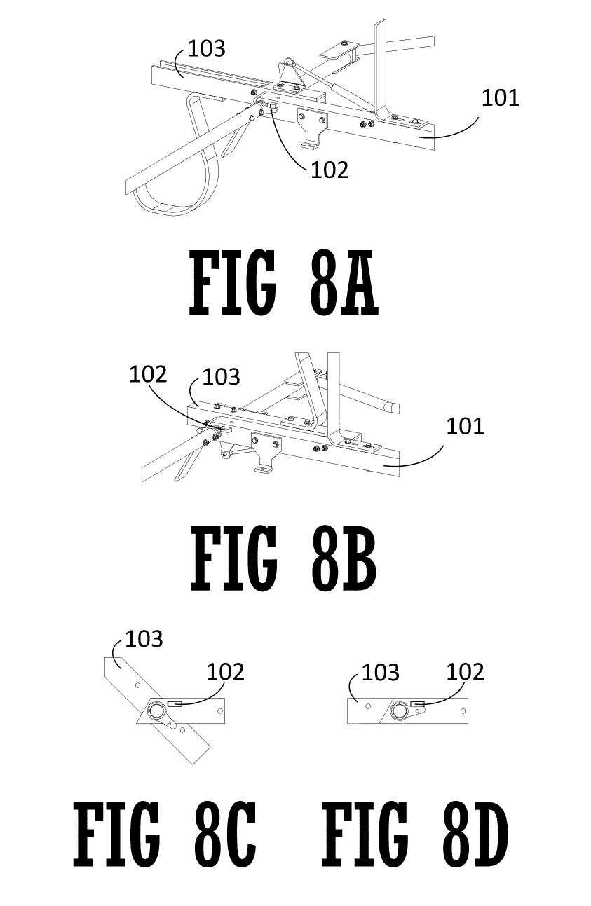

FIG. 9A is a top view of an embodiment of the ergonomic ladder rack showing the positioning of the handle in the partially open position; FIG. 9B is a top view of an embodiment of the ergonomic ladder rack showing the positioning of the handle in the fully closed. FIGS. 9A and 9B should be viewed in conjunction with FIGS. 8A, 8B, 8C and 8D.

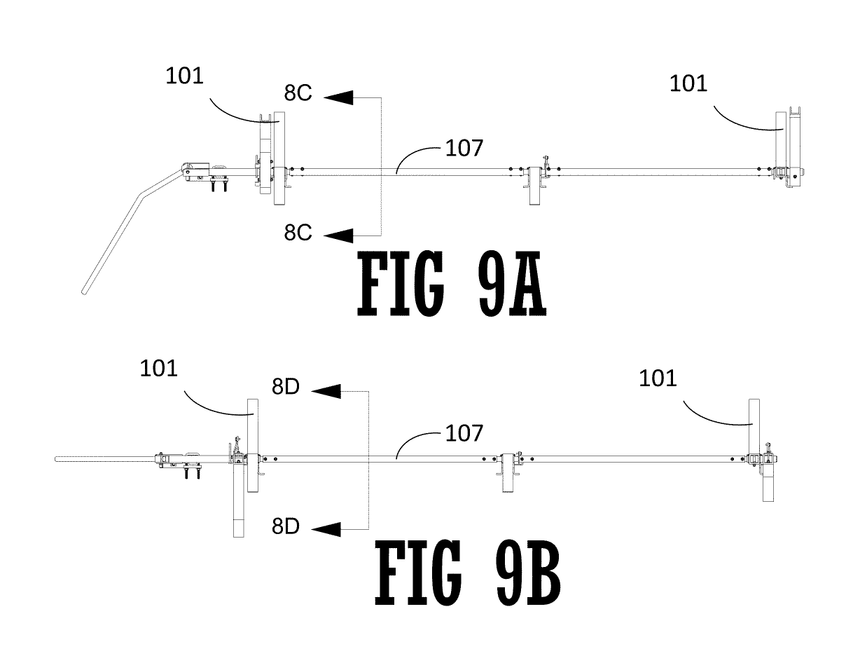

FIG. 10 is a perspective view of an embodiment of the ergonomic ladder rack fixed cross-member and ladder support arm.

FIG. 11A is a side view of an embodiment of the ergonomic ladder rack showing a ladder mounted on the ergonomic ladder rack in the fully closed position; FIG. 11B is a side view of an embodiment of the ergonomic ladder rack with a ladder mounted on the ladder rack showing the ladder rack in the partially open position; FIG. 11C is a side view of an embodiment of the ergonomic ladder rack showing a ladder mounted in the ergonomic ladder rack with the ladder rack in the half open position; FIG. 11D is a side view of an embodiment of the ergonomic ladder rack with a ladder installed showing the ergonomic ladder rack in the nearly open position; FIG. 11E is a side view of an embodiment of the ergonomic ladder rack with a ladder installed with the ergonomic ladder rack in the fully open position. Taken together, FIGS. 11A through 11E show an embodiment of the ergonomic ladder rack moving from a fully closed position to a fully open position.

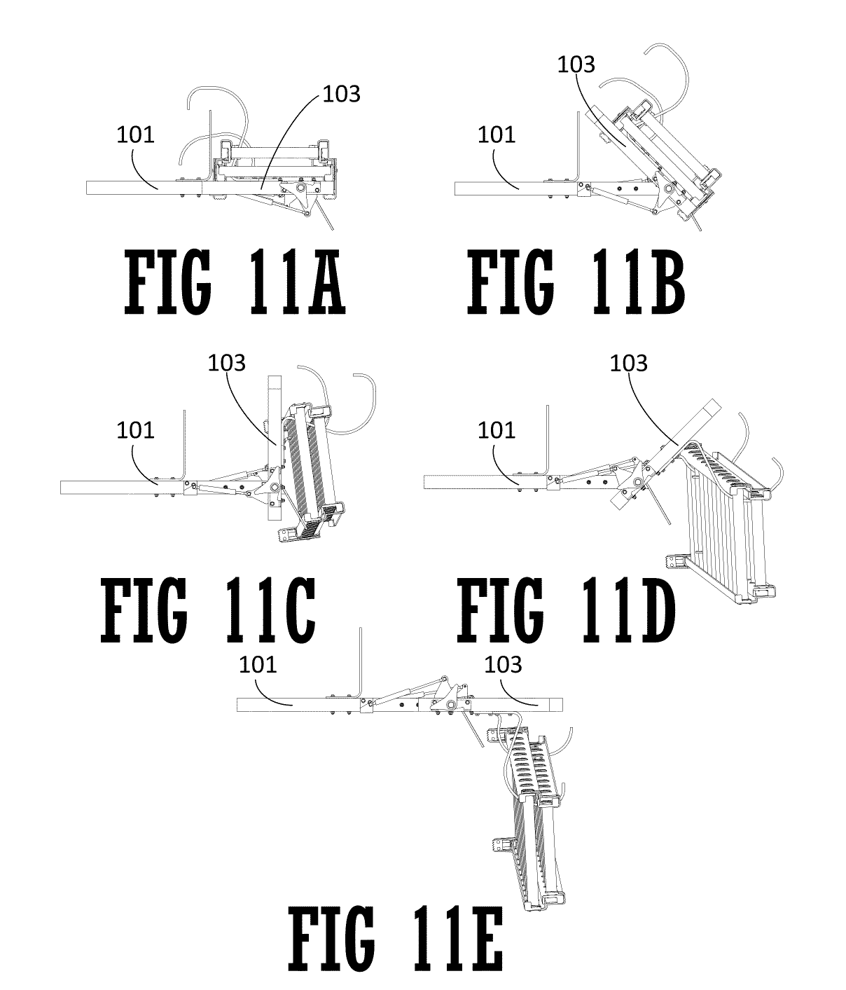

FIG. 12A is a side view of an embodiment of the ergonomic ladder rack showing the wing bracket on a ladder support arm mounted on the ergonomic ladder rack in the fully closed position; FIG. 12B is a side view of an embodiment of the ergonomic ladder rack showing the wing bracket on a ladder support arm mounted on the ergonomic ladder rack in the partially open position; FIG. 12C is a side view of an embodiment of the ergonomic ladder rack showing the wing bracket on a ladder support arm mounted on the ergonomic ladder rack in a more open position; FIG. 12D is a side view of an embodiment of the ergonomic ladder rack showing the wing bracket on a ladder support arm mounted on the ergonomic ladder rack in the nearly open position; FIG. 12E is a side view of an embodiment of the ergonomic ladder rack showing the wing bracket on a ladder support arm mounted on the ergonomic ladder rack in the fully open position. Taken together and in order, FIGS. 12A through 12E show an embodiment of the ergonomic ladder rack moving from a fully closed position to a fully open position.

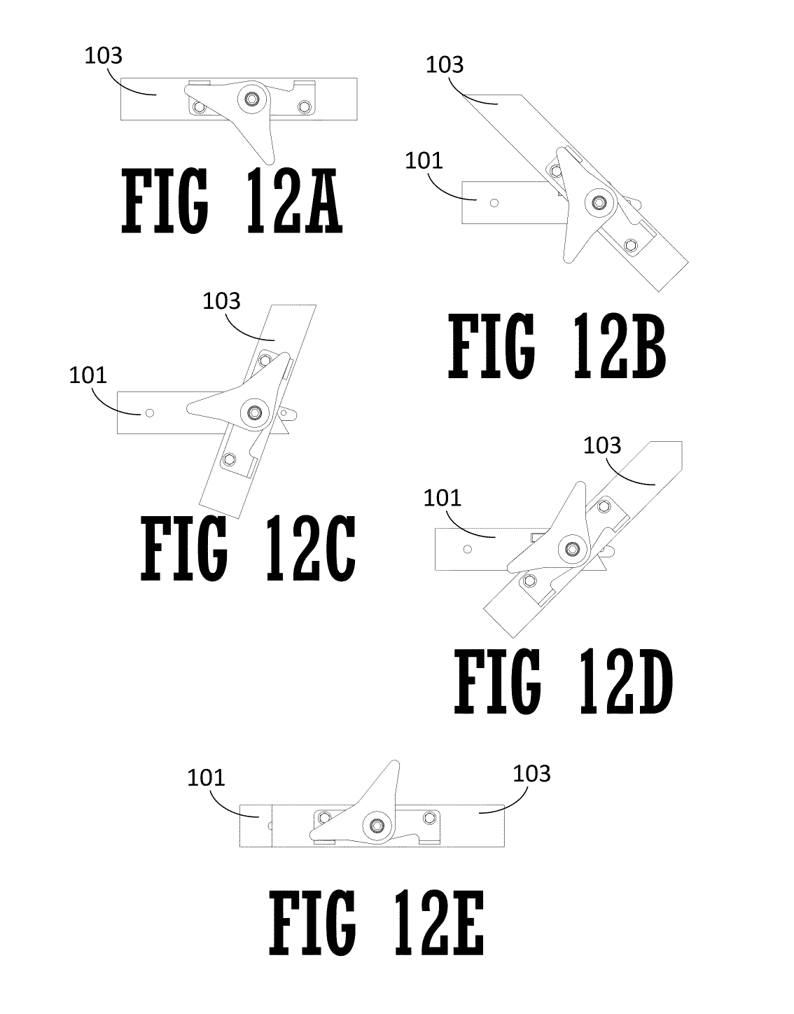

FIG. 13A is a side view of an embodiment of the ergonomic ladder rack showing the wing bracket on a ladder support arm mounted on the ergonomic ladder rack in the fully open position; FIG. 13B is a side view of an embodiment of the ergonomic ladder rack showing the wing bracket on a ladder support arm mounted on the ergonomic ladder rack in the nearly open position; FIG. 13C is a side view of an embodiment of the ergonomic ladder rack showing the wing bracket on a ladder support arm mounted on the ergonomic ladder rack in the half open position; FIG. 13D is a side view of an embodiment of the ergonomic ladder rack showing the wing bracket on a ladder support arm mounted on the ergonomic ladder rack in the partially open position; FIG. 13E is a side view of an embodiment of the ergonomic ladder rack showing the wing bracket on a ladder mounted on the ergonomic ladder rack in the closed position. Taken together and in order, FIGS. 13A through 13E show an embodiment of the ergonomic ladder rack moving from a fully open position to a fully closed position.

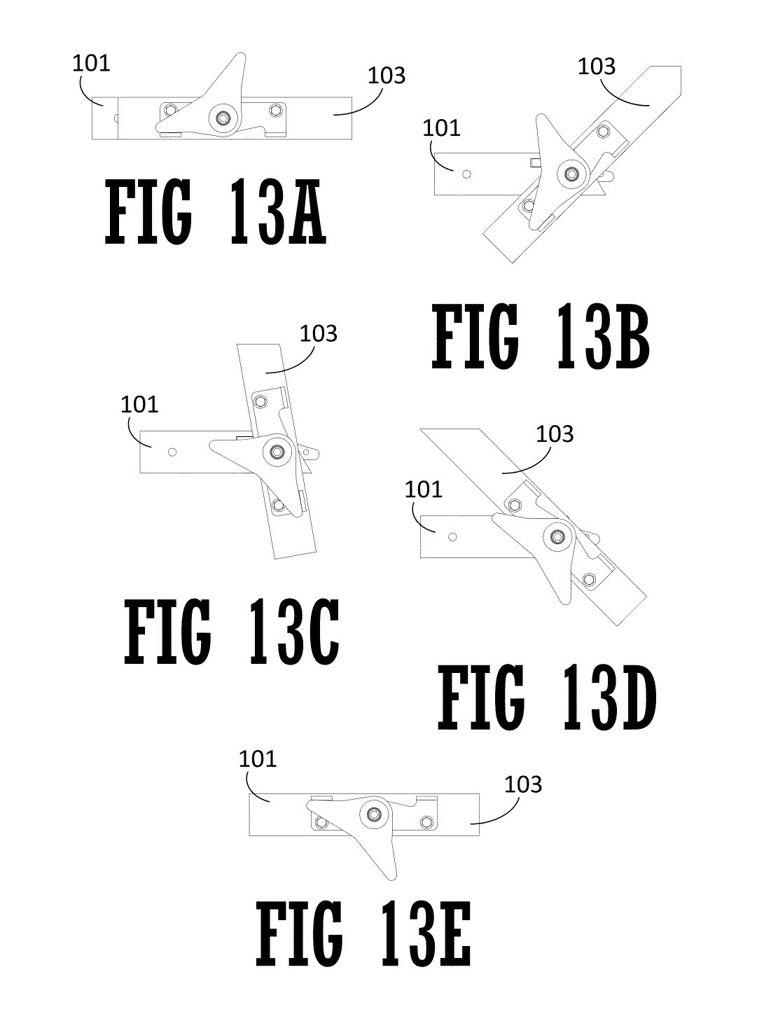

FIG. 14A is a sectional view of an embodiment of the ergonomic ladder rack showing mechanical connections between the handle and the outer rotatable tube, the rotatable axis, and the connection tube; FIG. 14B is a top view of an embodiment of the ergonomic ladder rack showing mechanical connections between the handle and the outer rotatable tube, the rotatable axis, and the connection tube.

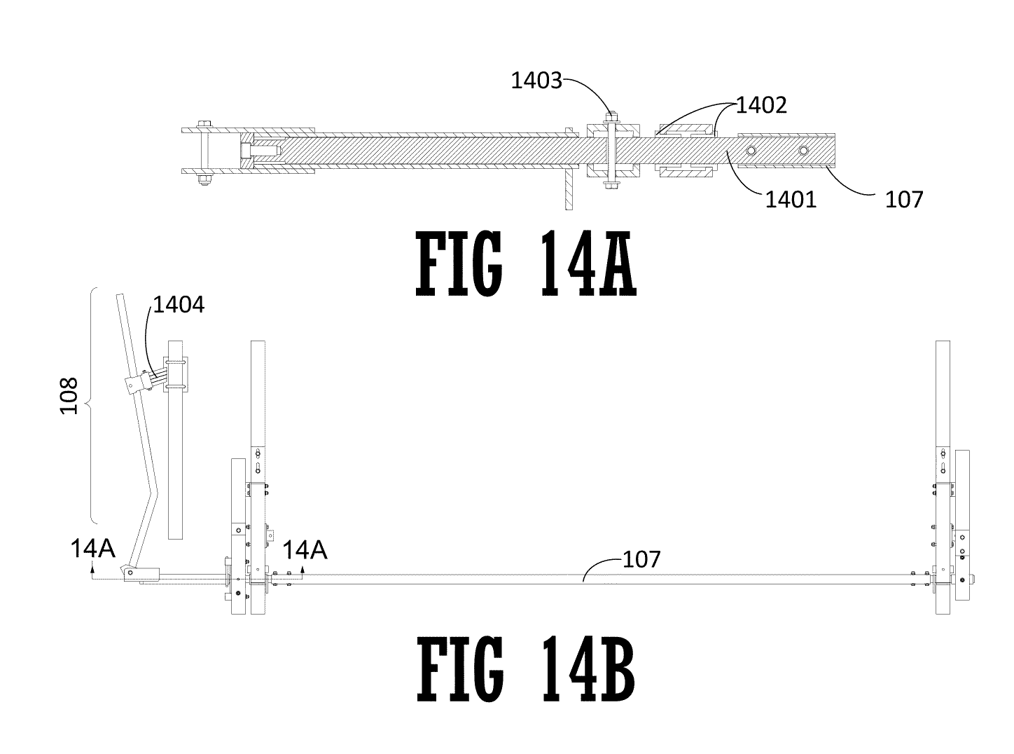

FIG. 15 is an exploded view of an embodiment of the ergonomic ladder rack showing mechanical connections between the handle and the outer rotatable tube, the rotatable axis, and the connection tube.

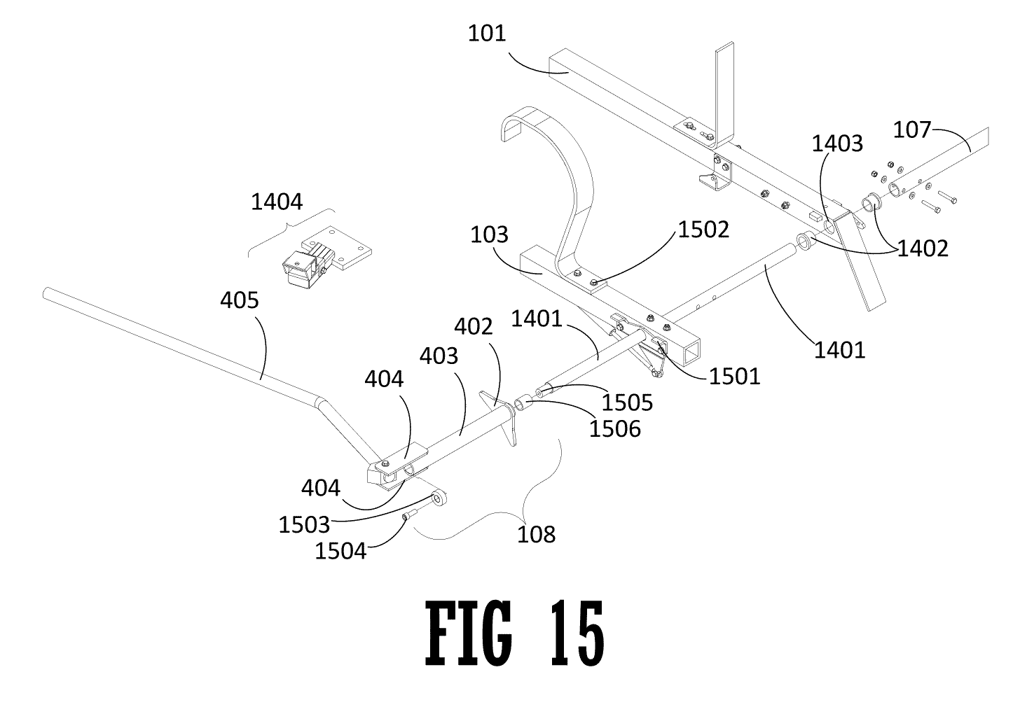

FIG. 16 is a perspective view of an embodiment of the ergonomic ladder rack showing mechanical connections between the handle and the outer rotatable tube, the rotatable axis, and the connection tube.

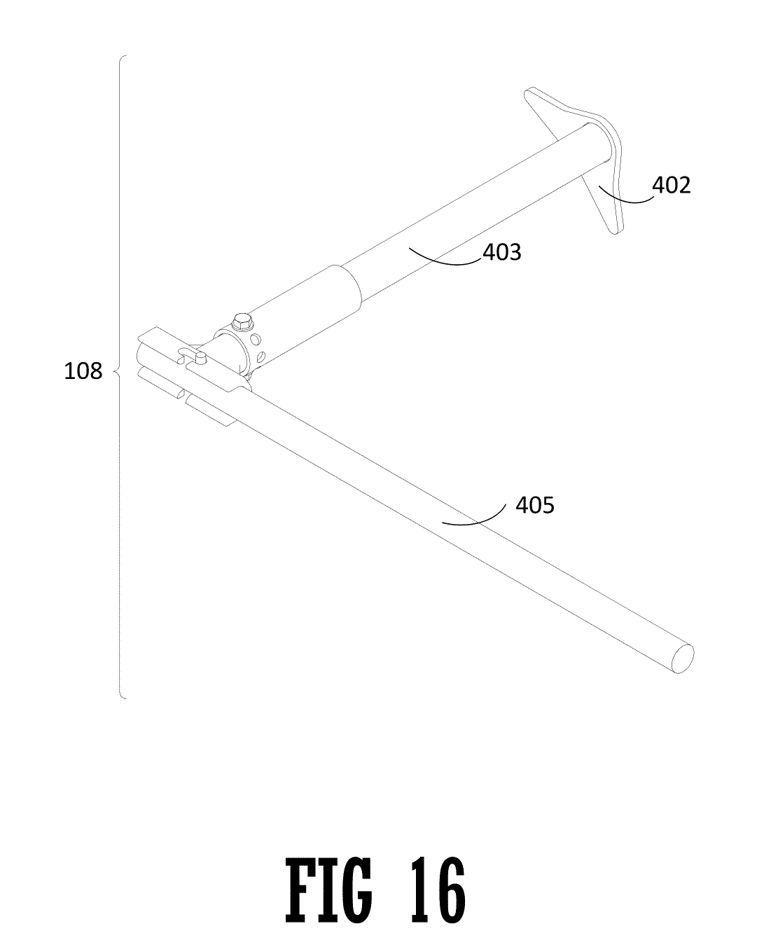

FIG. 17A is an exploded view of an embodiment of the ergonomic ladder rack showing the mechanical connections between the handle, the handle saddle bracket and the outer rotatable; FIG. 17B is an exploded view of an embodiment of the ergonomic ladder rack showing the mechanical connections between the handle saddle bracket and the outer rotatable tube; FIG. 17C is an exploded view of an embodiment of the ergonomic ladder rack showing the mechanical connections between the handle saddle bracket and the outer rotatable tube.

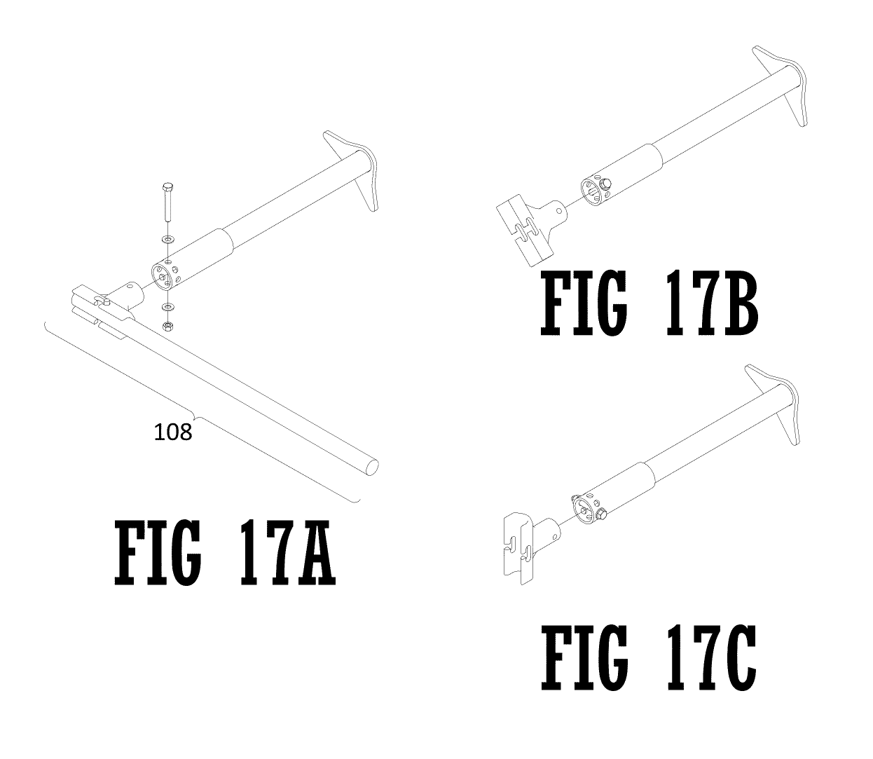

FIG. 18 is an exploded view of an embodiment of the ergonomic ladder rack showing the mechanical connections between the handle and the handle saddle bracket.

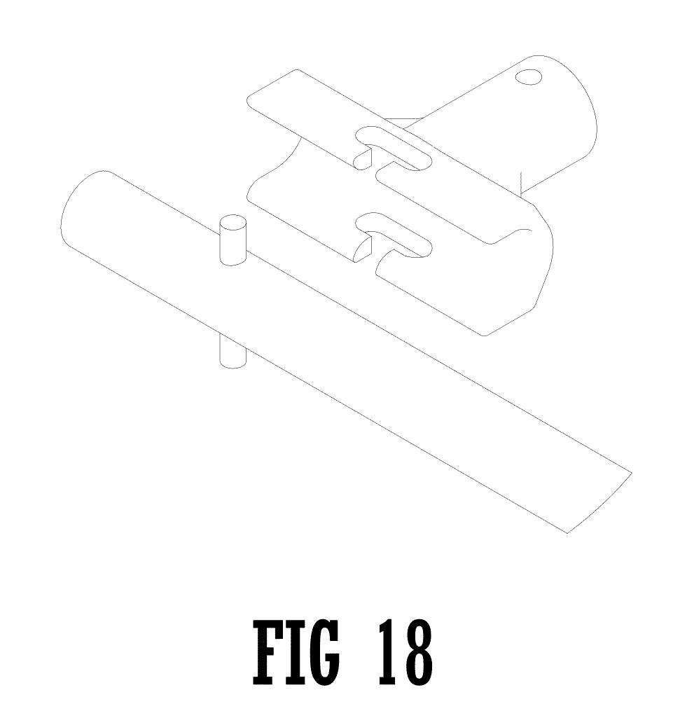

### DETAILED DESCRIPTION OF THE PREFERRED EMBODIMENTS

Embodiments of the Ergonomic Ladder Rack 100 are comprised of two or more fixed cross-members 101, one or more inner axis rods 1401, one or more stops 102, two or more ladder support arms 103, one or more fluid or gas filled dampers 104, two or more ladder hooks 105, two or more ladder stop/securing arms 106, one or more connecting tubes 107, and a handle assembly 108.

The two or more fixed cross-members 101 are attached to a motor vehicle, spaced apart in such a way as to traverse much of the length of the motor vehicle. The two or more fixed cross-members 101 form a hole bored through both vertical walls of the fixed cross-members close to the end located on the outboard side of the vehicle able to accept one or more anti-friction bushings 1402. The ladder support arms 103 also form a hole to accept the inner axis rod to run perpendicular through the ladder support arms 103 while affixing the ladder support arm to the inner axis rod by bolt and nut 1403 in such a way that the ladder support arm 103 lay in the same horizontal plane as the associated fixed cross-members 101 in both the closed/stored position and the open/access position and can rotate with the inner axis rod 1401. The inner axis rod 1401 is placed perpendicular through the anti-friction bushings 1402.

Embodiments of the Ergonomic Ladder Rack 100 comprise a storage bracket 1404. The storage bracket 1404 allows for the secure storage of the handle assembly 108 while the vehicle is in motion or otherwise in a storage mode.

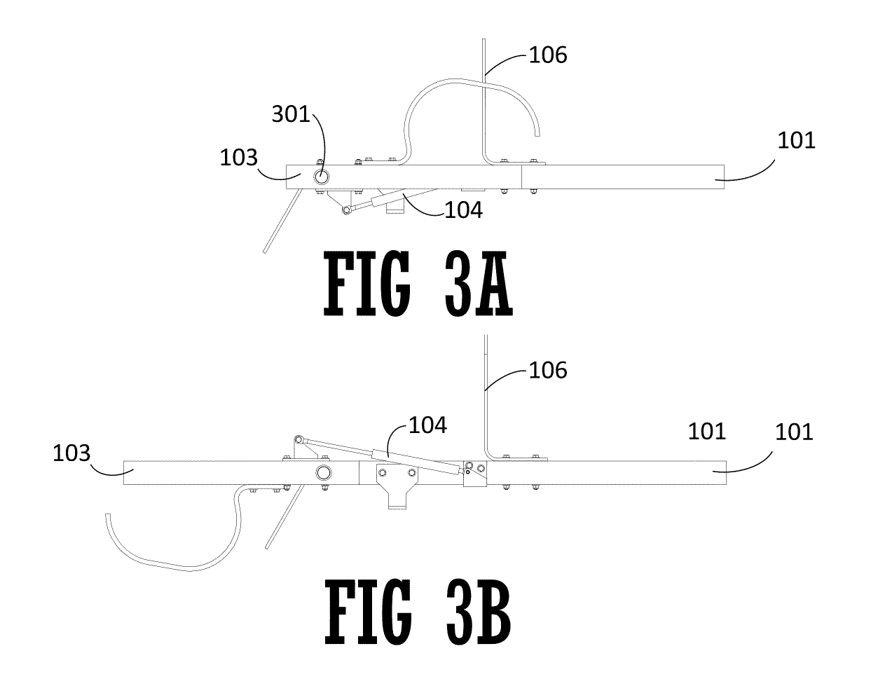

One stop 102 is affixed to each of the fixed cross-member. Another stop is a mounting brackets 401 which acts as another stop is attached to the other side of the fixed cross-member 101 from the first stop 102. The stop 102 and mounting bracket 401 are affixed to the fixed cross-members 101 so as to allow the inner axis rod 1401 to spin freely within the anti-friction bushings from the closed/stored position (see FIG. 3A) to the open/access position (see FIG. 3B) and back to the closed/stored position (see FIG. 3A).

The two or more ladder support arms 103 are comprised of a ladder support arm aperture 1501 formed by the ladder support arm 103, fastener connections 1502 to affix a ladder hook 105. An inner axis rod 1401 passes through the ladder support arm aperture 1501 and continues longitudinally allow the length of the Ergonomic Ladder Rack 100.

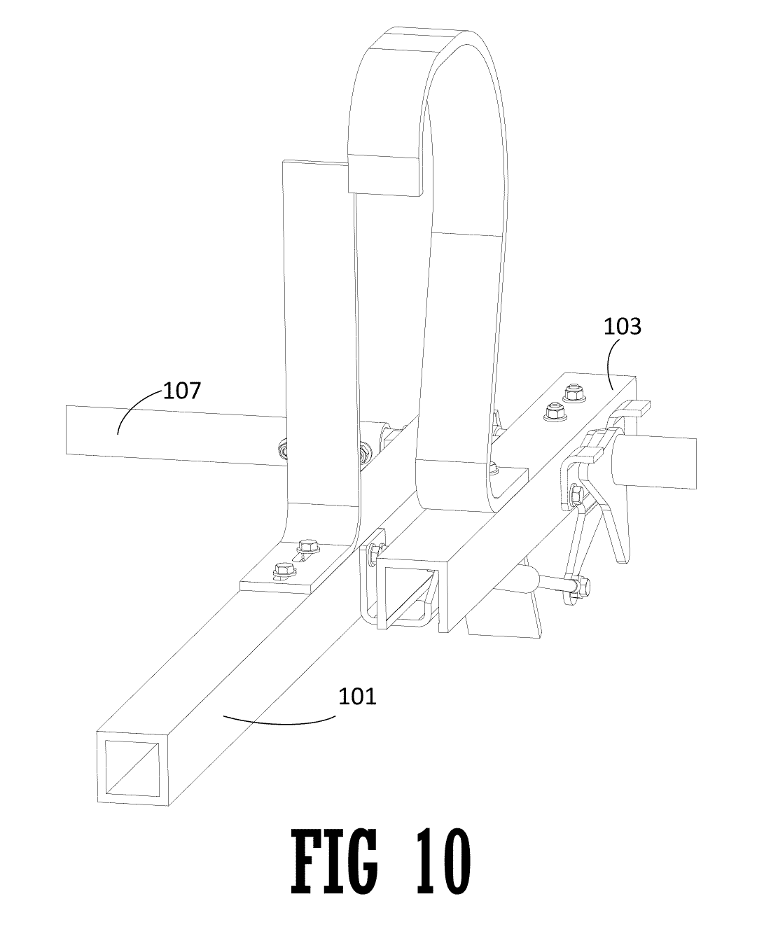

One end of the one or more fluid or gas filled dampers 104 are attached between the ladder support arm and the fixed cross-member with mounting brackets 401. The gas filled dampers 104 slows the rotation of the ladder support arm as it rotates from the closed/stored position to the open/access position and also back to the closed/stored position. The mounting brackets 401 serve as a cradle for the ladder support arms 103 when the ladder support arms 103 are in the closed position. See FIG. 10. In addition, when in the closed position, the ladder support arms 103 provide the fluid or gas filled dampers 104 protection from the sun and elements as the ladder support arms 103 will be positioned over and adjacent to the fluid or gas filled dampers 104.

The two or more ladder hooks with anti-friction padding fixed by bolt and nut to the ladder support arm in such a way to hold the ladder in the closed/stored position and allowing the ladder to slide along the path of the ladder hook while going from the closed/stored position to the open/access position and also back to the closed/stored position.

The two or more ladder stop/securing arms attached by bolt and nut to the fixed cross-member to stop the ladder from sliding from under the ladder hook while in the closed/stored position.

The one or more connecting tubes extend between each fixed cross-member and attaching by bolt and nut to each of the inner axis rods from the fixed cross-members and allowing each ladder support arms 103 to rotate in combination with the others from the closed/stored position to the open/access position and back to the closed/stored position.

One embodiment of the handle assembly 108 is comprised of a handle 405, a pair of support braces 404, a handle axis tube 403, a bat wing bracket 402, a rear bushing 1506, a front bushing 1503, and a securing bolt 1504. The support braces 404 and the bat wing bracket are weldedly attached to the handle axis tube 403. The handle 405 is connected to the support braces 404 via a pivoting fastener 406. The handle axis tube 403 is connected to an inner axis rod 1401 via securing bolt 1504 that passes through a front bushing 1503 and connects to a threaded end 1505 of an inner axis rod 1401. A rear bushing 1506 provides support for the handle axis tube 403 to rotate freely around the axis rod 1401, the handle axis tube 403 rotates around the inner axis rod 1401.

As the handle assembly 108 is rotated by the user, the bat wing bracket 402 transfers the torque from the to the first ladder support arm 103 via the ladder support arm brackets 1501. Once the bat wing bracket engages the ladder support arm brackets 1501, the ladder support arm 103 will rotate in the corresponding direction. The ladder support arm is directly connected to the inner axis rod 1401 and transfers torque accordingly to the inner axis rod 1401. The torque in the inner axis rod 1401 is in turn transferred to the second ladder support arm and any subsequent ladder support arms.

The handle bent in such a fashion as to provide easy access by user and also to simplify the rotation of the handle around the center axis of the rotatable tube. The handle comprises a locking mechanism to hold the handle in the closed/stored position while not in use. The handle also comprises a mounting bracket allowing the handle to be attached to a rotatable tube allowing the handle to be moved from the stored position to the open position and back to the stored position in such a way that the handle in the open position is approximately perpendicular to the center axis of the rotatable tube.

The rotatable tube in length moves the handle away from the closest fixed cross-member in such a way that the operator is clear of the swinging ladder. The rotatable tube shall freely rotate around one end of the inner axis rod, which rotates inside the closest fixed cross-member, without being attached in any way to the inner axis rod running through the fixed cross-member.

The stop device attached by bolt at the end of the inner axis rod holding the rotatable tube from sliding off but not affixing the inner axis rod to the rotatable tube. The rotatable tube comprises a pivot mechanism fixed on the end opposite the handle assembly and butting up against the nearest ladder support arm.

The ladder support arm shall have two protruding arms one on either side of the center of axis of the rotatable tube.

The pivot mechanism turns with the rotatable tube thus pushing against one of the protruding arms causing the ladder support arm to swing around the center of axis from the closed/stored position to the open/access position. The pivot mechanism shall press against the opposite protruding arm causing the ladder support arm to swing around the center of axis from the open/access position to the closed/stored position. The pivot mechanism is fashioned in such a way that once the ladder support arm reaches near vertical position, gravity shall allow the ladder support arm to fall without the effort of the handle/pivot mechanism. The pivot mechanism is not in contact with the protruding arms once the ladder support arm is affected by gravity.

In another embodiment, the handle assembly 108 is comprised of a handle 405, a handle saddle bracket 1601 which in turn connects this embodiment of the handle assembly 108 to the handle axis tube 403. The handle 405 is attached to the handle axis tube 403 via the handle saddle bracket 1601 and is secured via a saddle bracket bolt 1604, saddle bracket washers 1605 and a saddle bracket nut 1606 to a clock tube 1607. The clock tube 1607 is permanently affixed to the handle axis tube 403.

The handle saddle bracket 1601 forms a keyhole 1602 that accepts a pin 1603 secured on the handle 405. The user inserts the removable handle 405 into the saddle bracket 1601 and locks the handle 405 in position by inserting the pin 1603 into the keyhole 1602. The handle 405 in this embodiment can be inserted into the handle saddle bracket 1601 in either direction depending on the needs of the user. In addition, the orientation around the axis of the handle axis tube 403 can be adjusted by inserting the saddle bracket bolt 1604 in one of the plurality of clock holes 1608 formed by the clock tube 1607.

What we claimed is:

1) An ergonomic ladder rack comprised of two or more fixed cross-members;
an inner axis rod;
one or more stop mechanisms;
two or more ladder support arms;
one or more fluid or gas filled dampers;
two or more ladder hooks;
two or more ladder stop/securing arms;
one or more connecting tubes; and
a handle assembly.

2) The ergonomic ladder rack described in claim 1 comprised of the two or more fixed cross-members adapted to attach to a motor vehicle, spaced apart in such a way as to traverse much of the length of the motor vehicle;
vertical walls the fixed cross members forming a hole close to the end located on the outboard side of the vehicle to accept one or more anti-friction bushings;
an inner axis rod running perpendicular through the anti-friction bushings and through the fixed cross-members; and
one or more stop mechanisms are comprised of a stop a mounting brackets which acts as another stop wherein the stop and the mounting bracket are affixed to the fixed cross-members so as to allow the inner axis rod to spin freely within the anti-friction bushings from the closed/stored position to the open/access position and back to the closed/stored position.

3) The ergonomic ladder rack described in claim 2 comprised of
the two or more ladder support arms comprising two vertical walls with a hole bored through both vertical walls of the ladder support arm allowing for the inner axis rod to run perpendicular through the ladder support arm
the ladder support arm affixed to the inner axis rod by bolt and nut in such a way that the ladder support arm lay in the same horizontal plane as the fixed cross-member in both the closed/stored position and the open/access position and can rotate with the inner axis rod;
the one or more fluid or gas filled dampers attached between the ladder support arm and the fixed cross-member with mounting brackets, slowing the rotation of the ladder support arm as it rotates from the closed/stored position to the open/access position and also back to the closed/stored position;

4) The ergonomic ladder rack described in claim 3 wherein
the two or more ladder hooks comprise anti-friction padding and are affixed by bolt and nut to the ladder support arm in such a way to hold the ladder in the closed/stored position and allowing the ladder to slide along the path of the ladder hook while going from the closed/stored position to the open/access position and also back to the closed/stored position;
two or more ladder stop/securing arms attached by bolt and nut to the fixed cross-member to stop the ladder from sliding from under the ladder hook while in the closed/stored position; and
one or more connecting tubes extending between each fixed cross-member and attaching by bolt and nut to each of the inner axis rods extending out from the fixed cross-members and allowing each ladder support arms to rotate in combination with the others from the closed/stored position to the open/access position and back to the closed/stored position.

5) The ergonomic ladder rack described in claim 1 wherein
the handle assembly is comprised of a rotatable tube and a handle;
the handle bent in such a fashion as to provide easy access by user and also to simplify the rotation of the handle around the center axis of the rotatable tube;
a locking mechanism to hold the handle in the closed/stored position while not in use;
a mounting bracket allowing the handle to be attached to a rotatable tube allowing the handle to be moved from the stored position to the open position and back to the stored position in such a way that the handle in the open position is approximately perpendicular to the center axis of the rotatable tube;
a rotatable tube in length to move the handle away from the closest fixed cross-member in such a way that the operator is clear of the swinging ladder;
the rotatable tube shall freely rotate around one end of the inner axis rod, which rotates inside the closest fixed cross-member, without being attached in any way to the inner axis rod running through the fixed cross-member;
a stop device attached by bolt at the end of the inner axis rod holding the rotatable tube from sliding off but not affixing the inner axis rod to the rotatable tube;
the rotatable tube comprising a pivot mechanism fixed on the end opposite the handle assembly and butting up against the nearest ladder support arm;
the ladder support arm comprising two protruding arms one on either side of the center of axis of the rotatable tube;
the pivot mechanism comprising a rotatable tube thus pushing against one of the protruding arms causing the ladder support arm to swing around the center of axis from the closed/stored position to the open/access position;
the pivot mechanism shall press against the opposite protruding arm causing the ladder support arm to swing around the center of axis from the open/access position to the closed/stored position;
the pivot mechanism shall be fashioned in such a way that once the ladder support arm reaches near vertical position, gravity shall allow the ladder support arm to fall without the effort of the handle/pivot mechanism; and
the pivot mechanism shall not be in contact with the protruding arms once the ladder support arm is affected by gravity.

6) The ergonomic ladder rack described in claim 1 wherein
the handle assembly is comprised of a handle, a handle saddle bracket, a saddle bracket bolt, saddle bracket washers, and a saddle bracket nut, a clock tube and a handle axis tube;
wherein the handle saddle bracket connects the handle to the handle axis tube and is secured via the saddle bracket bolt, saddle bracket washers, and the saddle bracket nut to the clock tube;
wherein the clock tube is permanently affixed to the handle axis tube;
wherein the handle saddle bracket forms a keyhole that accepts a pin secured on the handle;
wherein the handle can be inserted into the handle saddle bracket in either direction;

7) The ergonomic ladder rack described in claim 5 wherein the orientation around the axis of the handle axis tube can be adjusted by inserting the saddle bracket bolt in one of the plurality of clock holes formed by the clock tube.

8) The ergonomic ladder rack described in claim 4 wherein
the handle assembly is comprised of a handle, a handle saddle bracket, a saddle bracket bolt, saddle bracket washers, and a saddle bracket nut, a clock tube and a handle axis tube;
wherein the handle saddle bracket connects the handle to the handle axis tube and is secured via the saddle bracket bolt, saddle bracket washers, and the saddle bracket nut to the clock tube;
wherein the clock tube is permanently affixed to the handle axis tube;
wherein the handle saddle bracket forms a keyhole that accepts a pin secured on the handle;
wherein the handle can be inserted into the handle saddle bracket in either direction;

9) The ergonomic ladder rack described in claim 8 wherein the orientation around the axis of the handle axis tube can be adjusted by inserting the saddle bracket bolt in one of the plurality of clock holes formed by the clock tube.
